(19) United States
(12) Patent Application Publication
(10) Pub. No.: US 2024/0409427 A1
(43) Pub. Date: Dec. 12, 2024

(54) LIMESTONE PRODUCTION

(71) Applicant: Worcester Polytechnic Institute, Worcester, MA (US)

(72) Inventors: Andrew R. Teixeira, Boylston, MA (US); Michael T. Timko, Arlington, MA (US); David Kenney, Farmingdale, NY (US)

(21) Appl. No.: 18/736,950

(22) Filed: Jun. 7, 2024

Related U.S. Application Data
(60) Provisional application No. 63/471,598, filed on Jun. 7, 2023.

(51) Int. Cl. C01F 11/18

(52) U.S. Cl. CPC C01F 11/183

(57) ABSTRACT

A recycling and waste management process receives municipal solid waste (MSW) with substantial organic content to form a self-sustaining Hydrothermal Mineralization (HTM) process based on Supercritical Water Oxidation (SCWO) to receive supercritical steam and carbon dioxide with potential for electrical generation before forming calcium carbonate suitable for concrete production. Hydrothermal mineralization (HTM) provides a rapid elimination of organic wastes while simultaneously producing a non-emissive and thermally stable cement additive to act as a carbon sink. Hydrothermal mineralization (HTM) provides a rapid disposal pathway for organic wastes, a green source of electricity and a final product that can be coupled with traditional and alternative cement productions to reduce carbon footprints of cement production.

### RELATED APPLICATIONS

This patent application claims the benefit under 35 U.S.C. § 119 (e) of U.S. Provisional Patent App. No. 63/471,598, filed Jun. 7, 2023, entitled “LIMESTONE PRODUCTION,” incorporated herein by reference in entirety.

### STATEMENT OF FEDERALLY SPONSORED RESEARCH AND DEVELOPMENT

This invention was developed with U.S. Government support under contract No. DE-EE0009507, awarded by the Department of Energy. The Government has certain rights in the invention.

### BACKGROUND

Considerable attention has been focused in recent decades on carbon dioxide emissions in view of detrimental environmental effects. In particular, two industries are a source of substantial carbon dioxide emissions: (1) Municipal and Industrial solid waste management and (2) Cement production. Municipal waste includes substantial quantities of organic material often referred to as organic municipal solid waste (MSW). Cement production is the most energy intensive phase of concrete generation. Both of these processes involve carbon dioxide (CO₂) which can be leveraged for energy production and raw materials for concrete production.

### SUMMARY

A recycling and waste management process receives municipal solid waste (MSW) with substantial organic content to form a self-sustaining Hydrothermal Mineralization (HTM) process based on Supercritical Water Oxidation (SCWO) to receive supercritical steam and carbon dioxide with potential for electrical generation before forming calcium carbonate suitable for concrete production. Hydrothermal mineralization (HTM) provides a rapid elimination of organic wastes while simultaneously producing a non-emissive and thermally stable cement additive to act as a carbon sink. Hydrothermal mineralization (HTM) therefore provides a rapid disposal pathway for organic wastes, a green source of electricity and a final product that can be coupled with traditional and alternative cement productions to reduce carbon footprints of cement production.

Configurations herein are based, in part, on the observation that carbon dioxide sequestration and reduction is beneficial for environmental health. Excessive emissions of carbon dioxide from fossil fuel combustion and other causes has become a high profile concern for governments and environmentalists. Unfortunately, conventional approaches to carbon dioxide reduction focus on elimination of the source of CO₂ generation through simply reducing output by urging or mandating elimination of sources, thus eliminating any benefits from the combustion as well. Accordingly, configurations herein substantially overcome the shortcomings of conventional approaches by providing a complementary consumer/receiver arrangement of CO₂ related processes. MSW, itself posing environmental concerns by the need for disposal, feeds a SCWO process were, once water attains a supercritical state, a pathway for hydrothermal mineralization from CO₂ generated from the SCWO feeds an HTM process for forming calcium carbonate directed to cement (concrete) production. Additionally, the high pressure water vapor and CO₂ from the supercritical reaction can be used to power a turbine, or other use of vapor under pressure, prior to HTM.

In further detail, configurations herein present a method for obtaining calcium carbonate through mineralization of a waste stream, including heating an aqueous waste stream such as municipal solid waste to a temperature and pressure for attaining a supercritical state of the water, and reacting hydrocarbons in the waste stream with oxygen to form carbon dioxide and water resulting from supercritical water oxidation. A mineralization reaction combining the CO₂ with calcium in the waste stream to form calcium carbonate, which is suitable for industrial and construction purposes such as concrete.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of the disclosed approach for receiving and recycling municipal solid waste (MSW) for carbon dioxide sequestration and concrete production;

FIG. 2 is an energy diagram for achieving a self-sustaining exothermic reaction in the environment of FIG. 1;

FIG. 3 is a comparison of the disclosed approaches with previous approaches for MSW processing and generating calcium carbonate or Precipitated Calcium Carbonate (PCC) as defined herein; and

FIG. 4 shows a stoichiometric level obtained by the disclosed approach as a plateau is approached, while direct air capture demonstrates substantially lower performance.

### DETAILED DESCRIPTION

The description below describes several configurations associated with the approach. Examples based on an experimental context are disclosed to illustrate the technical content of conversion of MSW to calcium carbonate and intermediate steps and compounds.

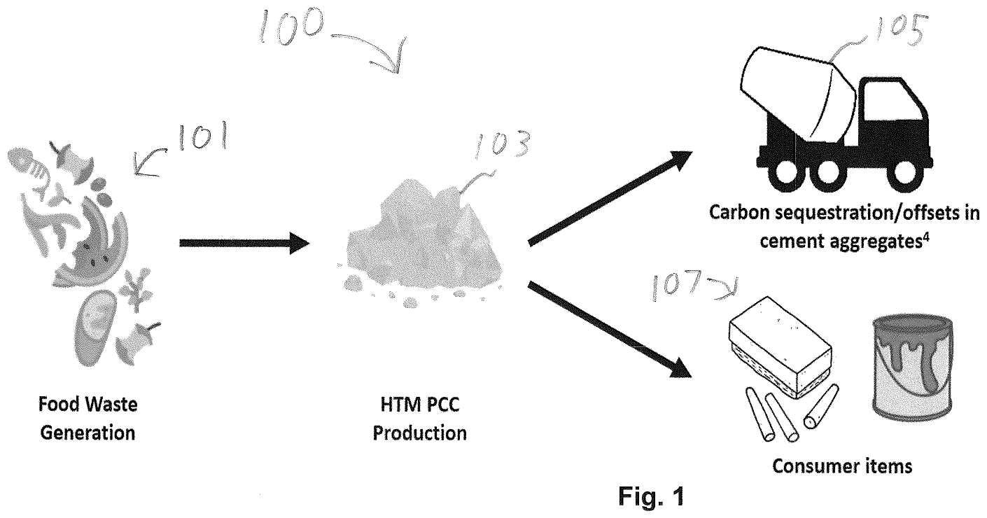

FIG. 1 is a context diagram of the disclosed approach for receiving and recycling municipal solid waste (MSW) for carbon dioxide sequestration and concrete production. Referring to FIG. 1, in a recycling environment 100, MSW 101 forms a recycling stream of organic waste with abundant and unspecific carbon and hydrogen comingled as discarded organic matter. The waste stream from the MSW 100 forms Precipitated Calcium Carbonate (PCC) through the approach described below. PCC is synthetic, generated calcium carbonate (CaCO₃) described below. The generated calcium carbonate may be used in concrete production 105, consumer goods 107 and any suitable outlet for calcium carbonate.

Supercritical water oxidation (SCWO) operates beyond the supercritical point of water (T>374° C., P>220 bar) under an oxidative environment to break down waste macromolecules to carbon dioxide in a matter of minutes. Due to the energy content of waste feeds (HHV_{food waste}=32.1 MJ/kg) the conversion to carbon dioxide is highly exothermic which means once steady state operation is achieved, the reaction requires no outside energy to operate. Once converted, the effluent stream is a high pressure, high temperature stream of supercritical carbon dioxide and water vapor. As an additional harvesting step, this stream can be expanded within a turbine to produce an excess of electricity that can be re-distributed back to the grid.

After leveraging the energy potential of the effluent stream, carbon dioxide will be sequestered in the form of calcium carbonate. This reaction takes place in an aqueous media under alkali conditions such that CO₂ is converted to bicarbonate (HCO₃⁻). From here, HCO₃⁻ will react with free calcium (Ca²⁺) to produce CaCO₃. This conversion is thermodynamically favorable, however, the dissolution of CO₂ into water to form HCO₃⁻ tends to be a rate limiting step. By leveraging the high pressure and purity of the effluent gas from the SCWO reaction, the disclosed approach overcomes issues surrounding dissolution rates.

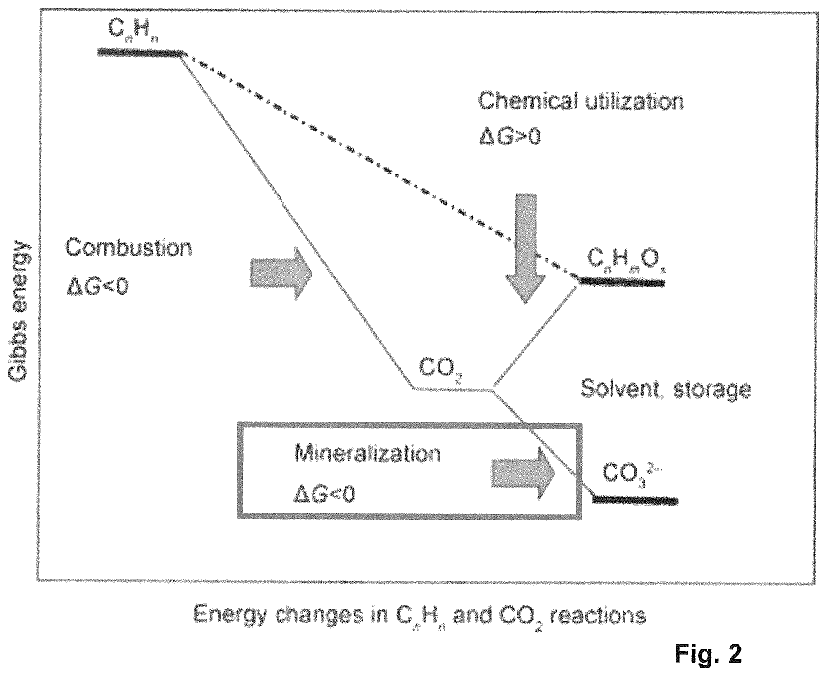

FIG. 2 is an energy diagram for achieving a self-sustaining exothermic reaction in the environment of FIG. 1. Referring to FIGS. 1 and 2, the disclosed method for obtaining calcium carbonate 103 through mineralization of a waste stream 101. A reactor or containment heats the aqueous waste stream to a temperature and pressure for attaining a supercritical state of the water. The waste stream includes substantial carbon and hydrogen in the form of organic waste. The heat reacts hydrocarbons in the waste stream 101 with oxygen in the oxidative environment to form carbon dioxide and water resulting from supercritical water oxidation. CO₂ from the waste stream dissolves into the water to form HCO₃⁻, which reacts with the carbon dioxide to form the calcium carbonate. The disclosed pathway for hydrothermal mineralization of food waste are defined by:

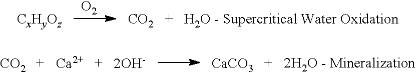

Thus, the CO₂ combines with calcium in the waste stream to form calcium carbonate. FIG. 2 illustrates that the mineralizing results from a negative Gibbs energy (ΔG value) change, as a positive Gibbs energy reaction would produce hydrocarbons for chemical utilization. A process that is spontaneous, or self sustaining corresponds to a negative ΔG value, as show in the mineralization phase in FIG. 2. SCWO relies on the unique reactivity and transport properties that occur when an aqueous waste stream is brought above the critical point of water (374° C. and 218 atm, or 704° F. and 3200 psi). Supercritical water is a dense single phase with transport properties similar to those of a gas, and solvent properties comparable to those of a non-polar solvent. Oxygen is fully soluble in supercritical water, resulting in extremely rapid and complete oxidation of all organics to carbon dioxide, clean water (that can be reused), and some non-leachable inorganic salts.

Of the 292 million tons of MSW generated in the United States, more than 70% are a form of organic waste. Most MSW organics retain a varying amount of water. Unlike traditional waste-to-energy processes such as incineration, hydrothermal methods such as SCWO can take wet organic wastes because the working fluid is water, resulting in a positive energy balance when other processes require energy inputs.

The full benefit of integrating the disclosed approach depends on the feed being used. This proposal is based on using food waste which is only 20% of all MSW generated in the United States. With full conversion, food waste could offset nearly 20% of the national demand for CaCO₃.

The disclosed approach therefore integrates SCWO and mineralization to produce CaCO₃. The approach serves at least three needs or industries: 1) CaCO₃ production, 2) Developers of CO₂ sequestration technologies, and 3) Waste management industries.

In conventional approaches, CaCO₃ demand is primarily satisfied in one of two forms. First is the mining of limestone directly. This production process revolves around mining limestone from open quarries or underground mines at which point it is ground down to a desired particle size. Secondly, is the precipitation of CaCO₃. Typically, precipitated calcium carbonate (PCC) is formed by hydrating, or slaking, quicklime (CaO) which has already been of a CO₂ molecule to form calcium hydroxide (Ca(OH)₂). CO₂ can then be converted to HCO₃⁻ and then react to form CaCO₃. Both of these conventional processes ultimately require the mining of CaCO₃ because quicklime is formed through the calcination of CaCO₃ and produces nearly 1.3 kg of CO₂/kg of CaO. To return to CaCO₃ the emissions are slightly improved to ˜1 kg CO₂/kg of PCC. In contrast, the disclosed approach requires no mining of CaCO₃, nor any soluble form of calcium and alkali environment. An example configuration employs calcium chloride (CaCl₂)) and sodium hydroxide (NaOH) as calcium and base sources, respectively. The use of traditional NaOH production our model shows a similar emission rate of ˜1 kg CO₂/kg PCC. However, if greener energy sources (i.e., solar, wind, biomass, etc.) are considered, it can be seen that this approach can actually reduce emissions by 50% down to 0.5 kg CO₂/kg PCC.

One approach is Direct Air Capture (DAC)/Point Source Capture (PSC), where the purpose for DAC and PSC technologies is to either remove or concentrate dilute CO₂ from the atmosphere or process flue gas. These processes are broken down into two main chemistries: 1) Mineralization and 2) Amine-based.

Mineralization focuses on the permanent removal of CO₂ through the formation of CaCO₃ or MgCO₃, two insoluble and thermally stable minerals. Deployed facilities have employed mineralization technology for DAC and purport to remove substantial quantities of CO₂ per year. However, since the disclosed approach pulls from a carbon-dense feed, removal efficiency is projected to be substantially greater than DAC if utilizing waste on a sufficiently large scale, depending on the moisture and carbon content of the process feed.

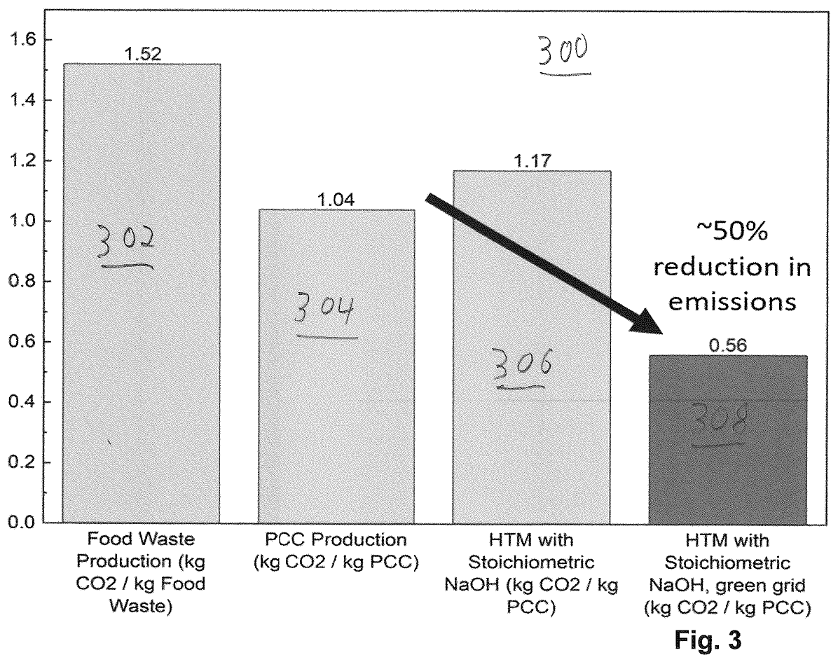

FIG. 3 is a comparison of the disclosed approaches with previous approaches for MSW processing and forming calcium carbonate or Precipitated Calcium Carbonate (PCC) as defined herein. Referring to FIGS. 1-3, FIG. 3 depicts a comparison 300 of several approaches in terms of a ratio of carbon dioxide.

Once landfilled, organic wastes are destined to degrade to CO₂ and CH₄ and are a significant Greenhouse Gas (GHG) emitter, shown by ratio 302. Traditional PCC production is often circular since it begins and ends with the mining of CaCO₃, shown as ratio 304. A particular configuration disclosed herein provides linear and finite end of life for food waste as CaCO₃ that is comparable to traditional PCC emissions, shown as ratio 306, however through the use of renewable energy sources (i.e., solar, wind, etc.), emissions can be reduced by 50%, shown as ratio 308.

Returning to FIGS. 1 and 2 and corresponding equations, a typical use case involves transporting a waste stream of MSW 101 or similar to a sealed containment or reactor adapted for pressurized operation. Application of heat accompanied by a sufficient pressure increase will force the water into a supercritical state. Following attainment of a steady state of the supercritical water, the heat source may be removed for allowing a self-sustaining exothermic reaction for producing the calcium carbonate.

In the example configuration, the waste stream is an organic waste stream, and the containment is employed to commence a supercritical water oxidation (SCWO) reaction through heating to at least 373° C. at a pressure of at least 220 bar in an oxidative environment to generate CO₂. The gaseous stream of carbon dioxide and water may be harvested by connecting a vessel or turbine input to the containment for powering an external load prior to mineralization. By engaging a vessel or conduit to the containment for receiving pressurized gases including carbon dioxide and water vapor, high pressure steam is available for powering a mechanical load.

Beyond mineralization, amine-based removal has proven to be effective at stripping CO₂ from gas streams. However, amine reactions are reversible which limits their ability to sequester CO₂. Amine-based removal is better for used for purification and transportation of CO₂. Further amines are expensive and corrosive, making them impractical for many applications. Conventional approaches have not coupled SCWO and mineralization in this manner to produce CaCO₃. The CO₂ becomes effectively sequestered in bicarbonate, and then mineralization consumes the CO₂ and free calcium to generate the calcium carbonate.

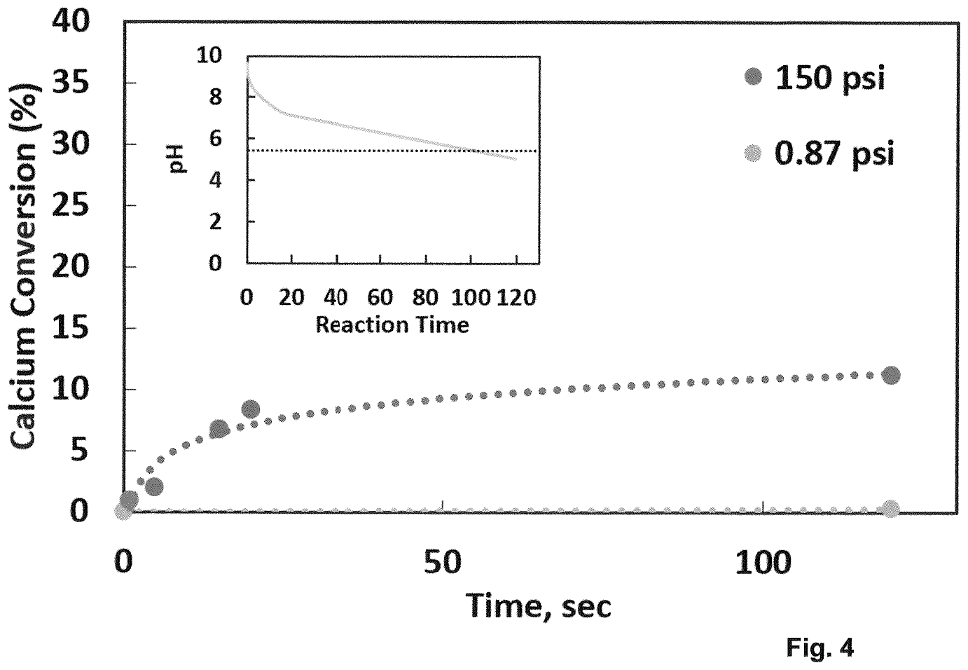

FIG. 4 shows a stoichiometric level obtained by the disclosed approach as a plateau is approached, while direct air capture demonstrates substantially lower performance. Referring to FIG. 4, the operating conditions depicted by the upper dotted line are for SCWO, at:
P_{CO}_{₂}=150 psi
T=20° C.
   The lower dotted line shows direct air capture (DAC):
P_{CO}_{₂}=0.87 psi
T=20° C.

For 150 psi, between 20-120 minutes the process begins to plateau at ˜10% conversion. This is a result of being sub stoichiometric in base and the pH dropping below 5.5. With stoichiometric amounts of base to Ca²⁺ the process yields complete or near complete conversion. Once supercriticality is obtained, mineralizing becomes a self-sustaining, spontaneous reaction having a negative delta G.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for obtaining calcium carbonate through mineralization of a waste stream, comprising:
heating an aqueous waste stream to a temperature and pressure for attaining a supercritical state of water in the aqueous waste stream;
reacting hydrocarbons in the waste stream with oxygen to form carbon dioxide and water resulting from supercritical water oxidation; and
combining the CO₂ with calcium in the waste stream to form calcium carbonate.

2. The method of claim 1, further comprising:
dissolving CO₂ from the waste stream into the water to form HCO₃⁻ and
reacting the form HCO₃⁻ with the carbon dioxide to form the calcium carbonate.

3. The method of claim 1, further comprising:
transporting the waste stream to a sealed containment adapted for pressurized operation;
following attainment of a steady state of the supercritical water; and
removing a source of heating for allowing a self-sustaining exothermic reaction for producing the calcium carbonate.

4. The method of claim 3, further comprising:
harvesting a gaseous stream of carbon dioxide and water for powering an external load.

5. The method of claim 1, wherein the waste stream is an organic waste stream, further comprising:
commencing a supercritical water oxidation (SCWO) reaction through heating to at least 373° C. at a pressure of at least 220 bar in an oxidative environment to generate CO₂;
sequestering the CO₂ in bicarbonate; and
mineralizing the CO₂ and free calcium to generate the calcium carbonate.

6. The method of claim 5, wherein the mineralizing results from a negative Gibbs energy change.

7. The method of claim 6, wherein mineralizing is a self-sustaining, spontaneous reaction having a negative delta G.

8. The method of claim 6, wherein mineralizing yields CO₃²⁻.

9. A device for supercritical water oxidation and mineralization, comprising:
a sealed vessel adapted for pressure and temperature to contain and heat an aqueous waste stream to a temperature and pressure for attaining a supercritical state of water in the aqueous waste stream;
the supercritical water reacting hydrocarbons in the waste stream with oxygen to form carbon dioxide and water resulting from supercritical water oxidation; and
the containment allowing a self-sustaining exothermic reaction for producing calcium carbonate from combining the CO₂ with calcium in the waste stream.

10. The method of claim 9, further comprising a vessel coupled to the containment for receiving pressurized gases including carbon dioxide and water vapor for powering a mechanical load.
